(19) United States
(12) Patent Application Publication
(10) Pub. No.: US 2024/0013671 A1
(43) Pub. Date: Jan. 11, 2024

(54) COMPUTER-READABLE RECORDING MEDIUM STORING QUESTION COLLECTION CREATING PROGRAM, QUESTION COLLECTION CREATING APPARATUS, AND METHOD OF CREATING QUESTION

(71) Applicant: Fujitsu Limited, Kawasaki-shi (JP)

(72) Inventor: Yutaro OMOTE, Ota (JP)

(73) Assignee: Fujitsu Limited, Kawasaki-shi (JP)

(21) Appl. No.: 18/298,521

(22) Filed: Apr. 11, 2023

(30) Foreign Application Priority Data
Jul. 5, 2022 (JP) 2022-108567

(51) Int. Cl. G09B 7/12; G09B 7/077

(52) U.S. Cl. CPC G09B 7/12; G09B 7/077

(57) ABSTRACT

A non-transitory computer-readable recording medium stores a question collection creating program for causing a computer to execute a process including: determining a criterion based on a difference between a correct answer rate of at least one machine learning model for a plurality of questions and a correct answer rate of a learner for the plurality of questions; selecting, from among the plurality of questions, one or a plurality of questions with which the correct answer rate of the at least one machine learning model becomes a value that corresponds to the criterion; and outputting the one or the plurality of selected questions as a question collection for the learner.

### CROSS-REFERENCE TO RELATED APPLICATION

This application is based upon and claims the benefit of priority of the prior Japanese Patent Application No. 2022-108567, filed on Jul. 5, 2022, the entire contents of which are incorporated herein by reference.

### FIELD

The technique disclosed herein is related to a computer-readable recording medium storing a question collection creating program, a question collection creating apparatus, and a method of creating a question collection.

### BACKGROUND

Nowadays, a generation model generated by machine learning with a dataset of a certain kind of question and answer as training data is used to extract sets of questions and answers from, for example, sentences of a textbook or the like, and thereby automatically generating a question collection. In such automatic generation of a question collection, when the content of a presented question is excessively difficult or excessively easy with respect to the degree of understanding of a learner, the learner's willingness may be reduced and training is not necessarily efficiently performed. Thus, desirably, the question to be presented may be controlled corresponding to the degree of understanding of the learner.

Japanese Laid-open Patent Publication Nos. 2010-266855 and 2012-093691 are disclosed as related art.

### SUMMARY

According to an aspect of the embodiments, a non-transitory computer-readable recording medium stores a question collection creating program for causing a computer to execute a process including: determining a criterion based on a difference between a correct answer rate of at least one machine learning model for a plurality of questions and a correct answer rate of a learner for the plurality of questions; selecting, from among the plurality of questions, one or a plurality of questions with which the correct answer rate of the at least one machine learning model becomes a value that corresponds to the criterion; and outputting the one or the plurality of selected questions as a question collection for the learner.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of a question collection creating apparatus;

FIG. 2 is a diagram for explaining a G model that creates a QA set from a sentence;

FIG. 3 is a diagram for explaining a QA model that outputs an answer to an input question;

FIG. 4 is a diagram for explaining a calculation of a correct answer rate;

FIG. 5 is a diagram for explaining determination of a criterion and selection of a question;

FIG. 6 is a graph illustrating an example of f(x) used to determine the criterion;

FIG. 7 is a block diagram schematically illustrating a configuration of a computer functioning as the question collection creating apparatus;

FIG. 8 is a flowchart illustrating an example of a first machine learning process;

FIG. 9 is a flowchart illustrating an example of a QA set creating process;

FIG. 10 is a flowchart illustrating an example of a second machine learning process; and

FIG. 11 is a flowchart illustrating an example of a question collection creating process.

### DESCRIPTION OF EMBODIMENTS

For example, a method has been proposed in which a new training exercise corresponding to a selected training item is automatically generated based on a model and other information on a current ability of a specific learner. The method includes a step of determining a target training item in accordance with an event and a step of obtaining a knowledge level of a learner related to the target training item based on a model of the learner created by an automated learner model. This method also includes a step of associating the obtained knowledge level of the learner and a difficulty level with each other and a step of obtaining a training exercise pattern from an exercise pattern database. This method also includes a step of automatically generating a training exercise related to the obtained training exercise pattern based on the model of the learner and the associated difficulty level.

Also, a technique has been proposed that assists effective review by finely grasping a learning level for each type of learning content and creates an exercise collection optimized for, for example, the learning level for each type of learning content. According to this technique, the learning content is subdivided into small units, all questions are registered in a database, the questions are classified into small units, and the degree of difficulty is assigned. According to this technique, an academic ability of a pupil is subdivided into small units, the academic ability is measured, a change in the academic ability is recorded as a history, and a result of solving a question is recorded as a history. A cram school server creates an academic ability grasping test for grasping the academic ability of the pupil on a small unit-by-small unit basis, creates a result report that clearly indicates the academic ability of the pupil based on a result of the academic ability grasping test, and creates an exercise collection for improving the academic ability of the pupil based on the result report. The cram school server verifies the degree of difficulty of questions classified on a small unit-by-small unit basis and on a degree of difficulty-by-degree of difficulty basis based on an answer history and varies the degree of difficulty as desired.

According to the techniques of related art, operations such as updating of the model based on an answer of the learner and maintenance of the degree of difficulty set for the questions are desired. Accordingly, man-hours are taken for creating the question collection corresponding to the degree of understanding of the learner.

In one aspect, an object of the disclosed technique is to reduce man-hours for creating a question collection corresponding to the degree of understanding of a learner.

Hereinafter, an example of an embodiment according to the disclosed technique will be described with reference to the drawings.

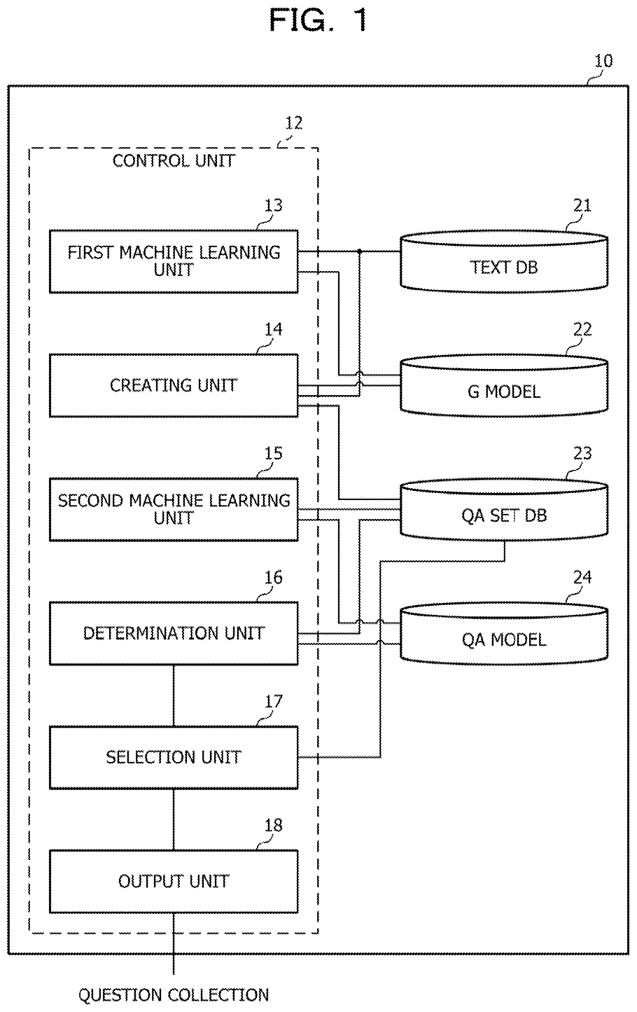

As illustrated in FIG. 1, a question collection creating apparatus 10 according to the present embodiment functionally includes a control unit 12. For example, the control unit 12 includes a first machine learning unit 13, a creating unit 14, a second machine learning unit 15, a determination unit 16, a selection unit 17, and an output unit 18. A text database (DB) 21, a G model 22, a QA set DB 23, and a QA model 24 are stored in a predetermined storage area of the question collection creating apparatus 10.

The text DB 21 stores a plurality of pieces of text data of sentences such as a textbook based on which a question collection is created. In some sentences, questions generated from the sentences and correct answers of the answers to the questions are provided. Hereinafter, among the sentences stored in the text DB 21 as text data, a sentence to which a question and correct answer of the answer to the question are provided is referred to as a “sentence with a correct answer”. However, in a case where a sentence with a correct answer and a sentence in which no correct answer is provided are described without distinction, both types of the sentences are simply referred to as a “sentence”.

The first machine learning unit 13 performs machine learning on the G model 22 that creates a set of a question and an answer from an input sentence (referred to as a “QA set” hereinafter) with a sentence with a correct answer as the training data. The G model 22 is an example of a “question creating model” of the disclosed technique. For example, the first machine learning unit 13 updates parameters of a pre-trained model such as, for example, a text-to-text transfer transformer (T5) by using the training data, thereby creating a question from the input sentence and generating the G model 22 that extracts the answer to the question. For example, the first machine learning unit 13 updates the parameters of the pre-trained model so as to minimize an error between a pair of the question created by the pre-trained model from the input sentence and the extracted answer and the question for the sentence input to the pre-trained model and a correct answer of the answer. The first machine learning unit 13 sets a model including the finally updated parameters as the G model 22 and stores the G model 22 in the predetermined storage area.

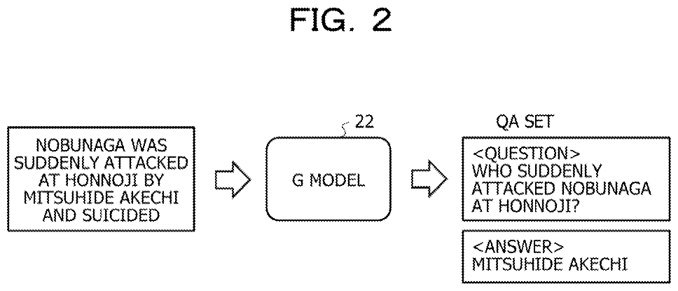

The creating unit 14 creates a plurality of QA sets by using the G model 22. For example, as illustrated in FIG. 2, the creating unit 14 creates a QA set by inputting each sentence stored in the text DB 21 to the G model 22 generated by the first machine learning unit 13. The creating unit 14 causes each of the plurality of created QA sets to be assigned with a corresponding one of question identifications (IDs) which are identification information and stored to the QA set DB 23.

The second machine learning unit 15 executes the machine learning of the QA model 24 that outputs an answer to an input question by using the QA set stored in the QA set DB 23 as the training data. The QA model 24 is an example of a “machine learning model” of the disclosed technique. For example, the second machine learning unit 15 generates the QA model by updating the parameters of the pre-trained model such as, for example, the T5 by using the training data. For example, the second machine learning unit 15 inputs the question included in the QA set to the pre-trained model and updates the parameters of the pre-trained model so as to minimize an error between an answer output from the pre-trained model and the answer included in the QA set, for example, the correct answer of the answer. The second machine learning unit 15 sets a model including the finally updated parameters as the QA model 24.

The second machine learning unit 15 generates a plurality of QA models 24 of different accuracies by executing the machine learning in which either or both of the number of parameters included in the QA model 24 and the number of pieces of training data used for the machine learning of the QA model 24 are varied. For example, the second machine learning unit 15 sets the QA model 24 generated in a case where the number of parameters and the number of pieces of training data are maximized as the QA model 24 of the best accuracy. By gradually reducing either or both of the number of parameters and the number of pieces of training data from the QA model 24 of the best accuracy, the second machine learning unit 15 generates a plurality of QA models 24 of the gradually reduced accuracies. A difference in accuracy between the QA models 24 corresponds to a difference in correct answer rate between answers output by the QA models 24 for the same question. The second machine learning unit 15 stores the plurality of generated QA models 24 in the predetermined storage area.

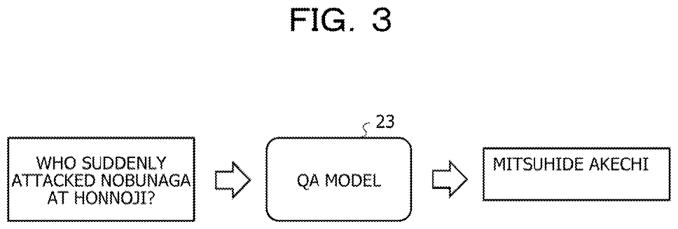

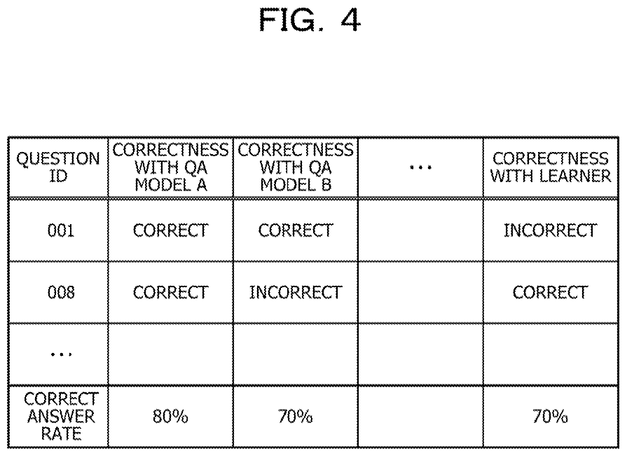

Based on the difference between the correct answer rate of the QA model 24 for a plurality of questions and the correct answer rate of a learner for the plurality of questions, the determination unit 16 determines a criterion representing the correct answer rate of the QA model 24 for a question collection planned to be created. For example, the determination unit 16 obtains a predetermined number of QA sets at random from the QA set DB 23 and, as illustrated in FIG. 3, inputs the questions included in the QA sets to each of the plurality of QA models 24 to obtain the answers. The determination unit 16 checks the answers output from the QA models 24 against the answers included in the QA sets and stores the correctness of the answers on a QA model 24-by-QA model 24 basis as illustrated in FIG. 4. The determination unit 16 presents the questions included in the same predetermined number of QA sets to learners and accepts the answers. For example, the determination unit 16 causes the output unit 18 which will be described later to transmit screen data (details of which will be described later) to information processing terminals used by the learners and accepts the answers input by the learners via the information processing terminals for the questions displayed in display units of the information processing terminals based on the screen data. Also for the answers of the learners, the determination unit 16 stores the correctness of the answers, for example, as illustrated in FIG. 4. For each of the plurality of QA models 24 and each of learners, the determination unit 16 calculates the correct answer rate (the number of correct answers/the number of presented questions) in the predetermined number of QA sets.

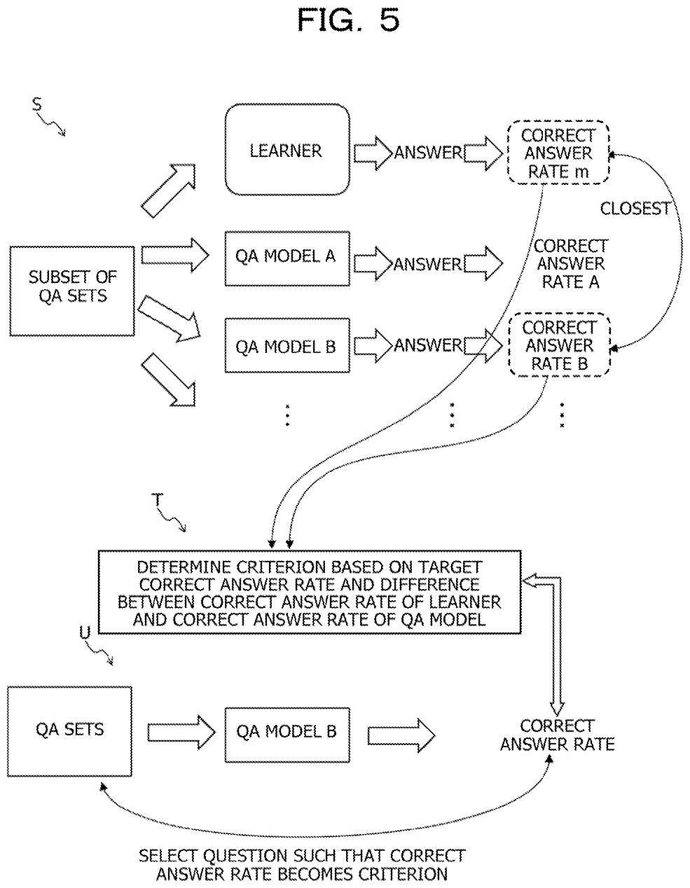

As indicated by S of FIG. 5, the determination unit 16 selects, from among the plurality of QA models 24, a QA model 24 of which the correct answer rate for the questions of the predetermined number of QA sets is closest to the correct answer rate of the learners. The example illustrated in FIG. 5 indicates a case where a correct answer rate m of the learners and a correct answer rate B of a QA model B are closest to each other, and the QA model B is selected. As indicated by T of FIG. 5, the determination unit 16 determines a criterion r based on a target correct answer rate t set by the learners for the question collection to be created next and the difference between the correct answer rate m of the learners and a correct answer rate n of the selected QA model 24. For example, the determination unit 16 determines the criterion r as described below.

$$r = t + f ( n - m ) , \\ f ( x ) = \{ \begin{matrix}( 1 - t ) x , ( x \geq 0 ) \\ tx , ( x \leq 0 )\end{matrix} , \\ - 1 \leq x \leq 1 , - t \leq f ( x ) \leq 1 - t$$

As the target correct answer rate t, a predetermined value that satisfies 0≤t≤1 (for example, 0.5) is set. The function f(x) is a function for calculating the criterion r by correcting the target correct answer rate t such that the target correct answer rate t increases as the correct answer rate of the QA model 24 increases compared to the correct answer rate of the learners and the target correct answer rate t reduces as the correct answer rate of the QA model reduces compared to the correct answer rate of the learners. For example, when t=0.5, the determination unit 16 calculates the criterion r as follows.

In a case where n−m=0, r=0.5,
in a case where n−m=0.2, r=0.6, and
in a case where n−m=−0.2, r=0.4.

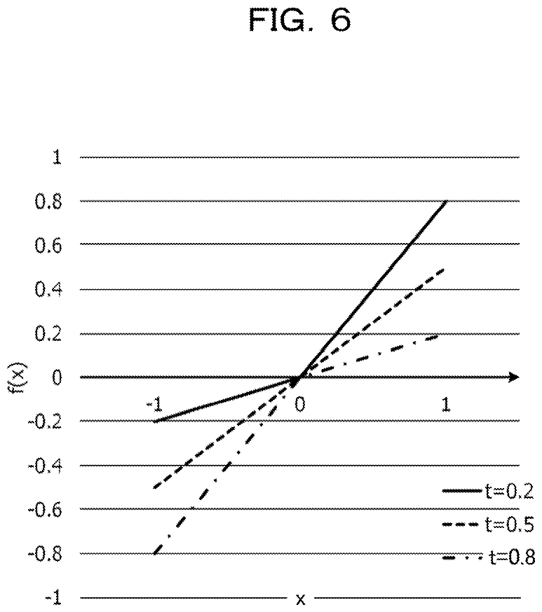

FIG. 6 illustrates an example of a graph of f(x) in a case where the target correct answer rate t varies.

As indicated by U of FIG. 5, the selection unit 17 selects, from among a plurality of questions, one or a plurality of questions with which the correct answer rate of the QA model 24 becomes a value corresponding to the criterion determined by the determination unit 16. For example, the selection unit 17 inputs each question of the QA sets stored in the QA set DB 23 to the QA model 24 selected by the determination unit 16 and stores the correctness for the question. According to the determined criterion, the selection unit 17 selects a predetermined number of questions from the correctly answered questions and a predetermined number of questions from the incorrectly answered questions. For example, in a case where the criterion r=0.5 (50%) and 20 questions are included in the question collection, the selection unit 17 selects 10 questions from among the questions correctly answered by the QA model 24 and 10 questions from among the questions incorrectly answered by the QA model 24. The selection from among the correctly answered questions and the incorrectly answered questions may be randomly made.

The output unit 18 outputs the one or the plurality of questions selected by the selection unit 17 as a question collection for the learners. For example, the output unit 18 generates the screen data for displaying, in the display unit of the information processing terminals used by the learners, a screen that includes the question selected by the selection unit 17 and an answer field and that is capable of accepting the answer input to the answer field, and the output unit 18 transmits the screen data to the information processing terminals of the learners.

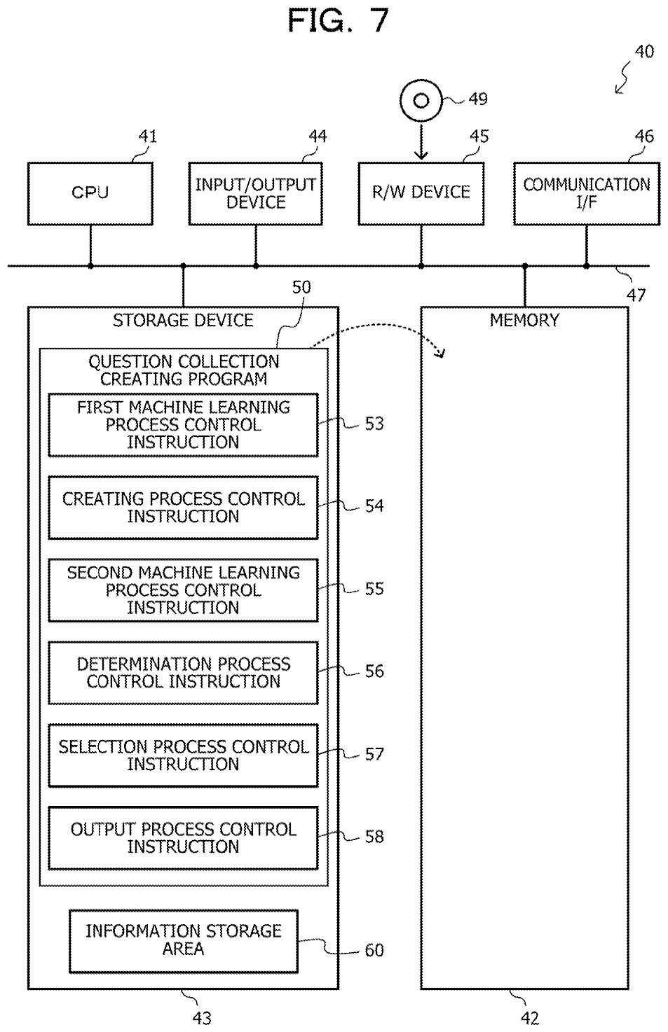

For example, the question collection creating apparatus 10 may be realized by a computer 40 illustrated in FIG. 7. The computer 40 includes a central processing unit (CPU) 41, a memory 42 serving as a temporary storage area, and a nonvolatile storage device 43. The computer 40 also includes an input/output device 44 such as an input device and a display device, and a read/write (R/W) device 45 that controls reading and writing of data from and to a storage medium 49. The computer 40 also includes a communication interface (I/F) 46 that is coupled to a network such as the Internet. The CPU 41, the memory 42, the storage device 43, the input/output device 44, the R/W device 45, and the communication I/F 46 are coupled to each other via a bus 47.

For example, the storage device 43 is a hard disk drive (HDD), a solid-state drive (SSD), a flash memory, or the like. A question collection creating program 50 for causing the computer 40 to function as the question collection creating apparatus 10 is stored in the storage device 43 serving as a storage medium. The question collection creating program 50 includes a first machine learning process control instruction 53, a creating process control instruction 54, a second machine learning process control instruction 55, a determination process control instruction 56, a selection process control instruction 57, and an output process control instruction 58. The storage device 43 includes an information storage area 60 in which information included in the text DB 21, the G model 22, the QA set DB 23, and the QA model 24 is stored.

The CPU 41 reads the question collection creating program 50 from the storage device 43, loads the question collection creating program 50 onto the memory 42, and sequentially executes the control instructions included in the question collection creating program 50. The CPU 41 operates as the first machine learning unit 13 illustrated in FIG. 1 by executing the first machine learning process control instruction 53. The CPU 41 operates as the creating unit 14 illustrated in FIG. 1 by executing the creating process control instruction 54. The CPU 41 operates as the second machine learning unit 15 illustrated in FIG. 1 by executing the second machine learning process control instruction 55. The CPU 41 operates as the determination unit 16 illustrated in FIG. 1 by executing the determination process control instruction 56. The CPU 41 operates as the selection unit 17 illustrated in FIG. 1 by executing the selection process control instruction 57. The CPU 41 operates as the output unit 18 illustrated in FIG. 1 by executing the output process control instruction 58. The CPU 41 reads the information from the information storage area 60 and loads each of the text DB 21, the G model 22, the QA set DB 23, and the QA model 24 onto the memory 42. In this way, the computer 40 that executes the question collection creating program 50 functions as the question collection creating apparatus 10. The CPU 41, which executes the program, is hardware.

The functions realized by the question collection creating program 50 may be realized by, for example, a semiconductor integrated circuit, in more detail, an application-specific integrated circuit (ASIC), a field-programmable gate array (FPGA), or the like.

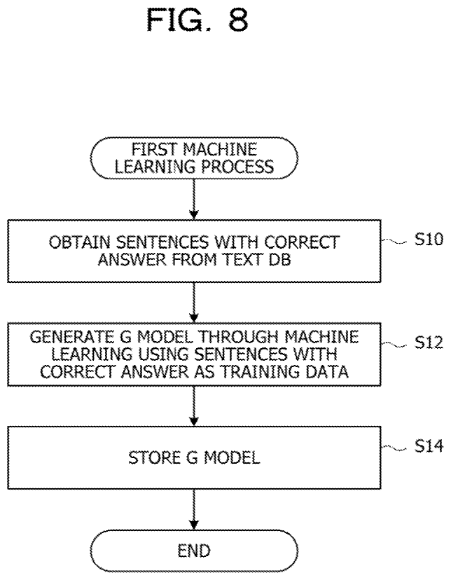

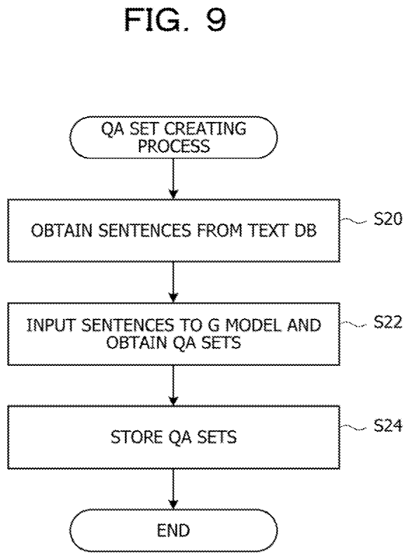

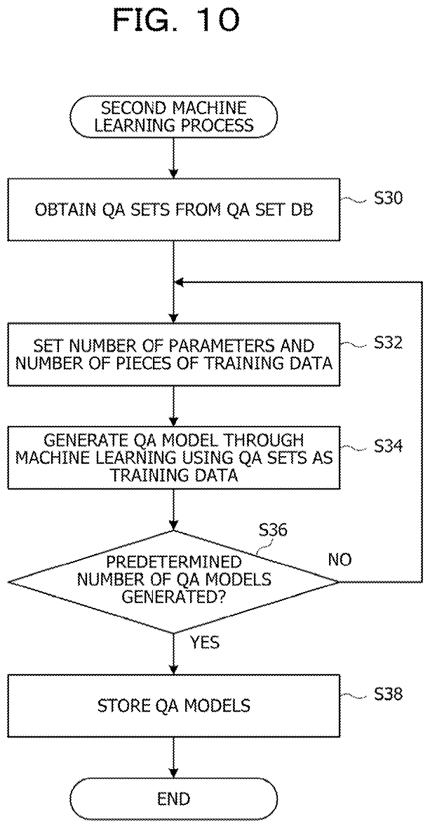

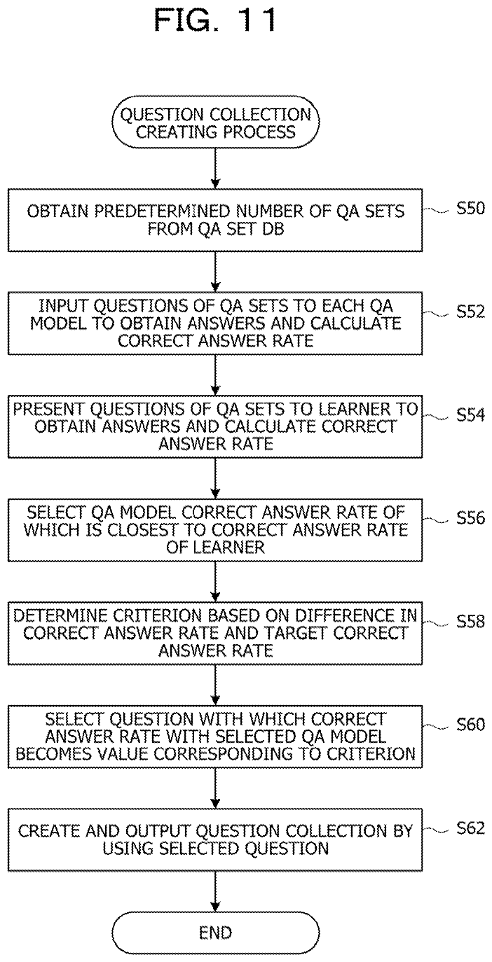

Next, an operation of the question collection creating apparatus 10 according to the present embodiment will be described. As preparation processing, the question collection creating apparatus 10 executes the first machine learning process illustrated in FIG. 8, the creating process illustrated in FIG. 9, and the second machine learning process illustrated in FIG. 10. In a case where a new question collection is created, the question collection creating apparatus 10 executes a question collection creating process illustrated in FIG. 11. The question collection creating process is an example of a method of creating a question collection of the disclosed technique.

First, the first machine learning process illustrated in FIG. 8 is described. The first machine learning process is started in a case where generation of the G model 22 is instructed in a state in which a plurality of sentences with a correct answer are stored in the text DB 21 of the question collection creating apparatus 10.

In step S10, the first machine learning unit 13 obtains a plurality of sentences with a correct answer from the text DB 21. Next, in step S12, the first machine learning unit 13 generates the G model 22 that creates the QA sets from the input sentences by executing the machine learning on a pre-trained model such as, for example, the T5 by using the obtained sentences with a correct answer as the training data. Next, in step S14, the first machine learning unit 13 stores the generated G model 22 in the predetermined storage area of the question collection creating apparatus 10, and the first machine learning process ends.

Next, a QA set creating process illustrated in FIG. 9 is described. The QA set creating process is started in a case where creation of the QA sets is instructed in a state in which the plurality of sentences are stored in the text DB 21 of the question collection creating apparatus 10 and the G model 22 is stored in the question collection creating apparatus 10.

In step S20, the creating unit 14 obtains a plurality of sentences from the text DB 21. Next, in step S22, the creating unit 14 inputs each of the obtained sentences to the G model 22 and obtains each of the QA sets output from the G model 22. Next, in step S24, the creating unit 14 causes each of the plurality of obtained QA sets to be assigned with the corresponding one of the question IDs and stores the QA sets with the question IDs in the QA set DB 23, and the QA set creating process ends.

Next, the second machine learning process illustrated in FIG. 10 is described. The second machine learning process is started in a case where the creation of the QA model 24 is instructed in a state in which a plurality of QA sets are stored in the QA set DB 23 of the question collection creating apparatus 10.

In step S30, the second machine learning unit 15 obtains the plurality of QA sets from the QA set DB 23. Next, in step S32, the second machine learning unit 15 sets the number of parameters of the QA model 24 to be generated and the number of pieces of training data to be used for the machine learning. Next, in step S34, the second machine learning unit 15 generates the QA model 24 that outputs the answers to the input questions by executing the machine learning on a pre-trained model such as, for example, the T5 by using the obtained QA sets as the training data.

Next, in step S36, the second machine learning unit 15 determines whether a predetermined number of QA models 24 have been generated. In a case where the predetermined number of QA models 24 have been generated, the process proceeds to step S38. In a case where the predetermined number of QA models 24 have not been generated, the process returns to step S32. In a case where the process returns to step S32, the second machine learning unit 15 sets the number of parameters and the number of pieces of training data that are respectively different from the number of parameters and the number of pieces of training data set for the QA models 24 having already been generated. In step S38, the second machine learning unit 15 stores the plurality of generated QA models 24 in the predetermined storage area of the question collection creating apparatus 10, and the second machine learning process ends.

Next, the question collection creating process illustrated in FIG. 11 is described. The question collection creating process is started in a case where the creation of the question collection is instructed in a state in which the plurality of QA sets are stored in the QA set DB 23 of the question collection creating apparatus 10 and the plurality of QA models 24 are stored in the question collection creating apparatus 10.

In step S50, the determination unit 16 randomly obtains a predetermined number of QA sets from the QA set DB 23. Next, in step S52, the determination unit 16 inputs the question included in each of the obtained QA sets to each of the plurality of QA models 24 to obtain the answers. The determination unit 16 checks the answers output from the QA models 24 against the answers included in the QA sets and calculates the correct answer rate on a QA model 24-by-QA model 24 basis. Next, in step S54, the determination unit 16 presents the questions included in the obtained QA sets to the learners, accepts the answers, and calculates the correct answer rate of the learners. The processing in step S52 and the processing in step S54 may be executed in parallel.

Next, in step S56, the determination unit 16 selects, from among the plurality of QA models 24, a QA model 24 the correct answer rate of which calculated in step S52 above is closest to the correct answer rate of the learners calculated in step S54 above. Next, in step S58, the determination unit 16 determines the criterion based on the target correct answer rate t set by the learners and the difference between the correct answer rate of the learners and the correct answer rate of the selected QA model 24.

Next, in step S60, the selection unit 17 selects from among the questions of the plurality of QA sets stored in the QA set DB 23 a question with which the correct answer rate of the QA model 24 selected in step S56 above is a value corresponding to the criterion determined in step S58 above. Next, in step S62, the output unit 18 creates and outputs the question collection by using the question selected in step S60 above, and the question collection creating process ends.

As has been described, a question collection creating apparatus according to the present embodiment determines a criterion based on the difference between a correct answer rate of a machine learning model for a plurality of questions and a correct answer rate of a learner for the plurality of questions. From among the plurality of questions, the question collection creating apparatus selects one or a plurality of questions with which the correct answer rate of the machine learning model becomes a value corresponding to the criterion and outputs the one or plurality of selected questions as a question collection for the learner. As described above, with the question collection creating apparatus according to the present embodiment, operations such as updating of the model based on an answer of the learner and maintenance of the degree of difficulty set for the questions are not desired. Accordingly, man-hours for creating the question collection corresponding the degree of understanding of the learner may be reduced.

Although a plurality of QA models are used in the above-described embodiment, the number of QA models may be one. Even in a case where a single QA model is used, when the criterion determined based on the difference between the correct answer rate of the QA model and the correct answer rate of the learners is used, a question with which the correct answer rate of the one QA model is a desired correct answer rate may be selected. As in the above-described embodiment, in the case where a plurality of QA models of different accuracies are used and a QA model of a correct answer rate closest to the correct answer rate of the learners is selected, the difference between the correct answer rate of the QA model used to determine the criterion and the correct answer rate of the learners may be reduced. Thus, the criterion corresponding to the degree of understanding of the learners may be determined with higher accuracy.

Although the predetermined number of questions are presented in the preparation processing for determining the criterion according to the above-described embodiment, this is not limiting. For example, the question collection creating apparatus may store the correct answer rate of the learners and the correct answer rate of the QA models for the question collection having been output in the past and may determine the criterion for creation of a question collection to be output newly by using the stored correct answer rate for the past question collection.

Although the question collection is created from the QA sets created by using the G model according to the above-described embodiment, the QA sets are not limited to those created by the G model. Separately prepared QA sets may be used.

Although the functional units are realized by a single computer according to the above-described embodiment, this is not limiting. For example, the determination unit 16, the selection unit 17, and the output unit 18 may be realized by one computer, and the first machine learning unit 13, the creating unit 14, and the second machine learning unit 15 may be realized by an other computer. Furthermore, any one of the first machine learning unit 13, the creating unit 14, and the second machine learning unit 15 or an appropriate combination of any of these may be realized by one or more than one computer.

Although the question collection creating program is stored (installed) in the storage device in advance according to the above-described embodiment, this is not limiting. The program according to the disclosed technique may be provided in a form of being stored in a non-transitory storage medium such as a compact disc read-only memory (CD-ROM), a Digital Versatile Disc (DVD)-ROM, a Universal Serial Bus (USB) memory, or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a question collection creating program for causing a computer to execute a process comprising:
determining a criterion based on a difference between a correct answer rate of at least one machine learning model for a plurality of questions and a correct answer rate of a learner for the plurality of questions;
selecting, from among the plurality of questions, one or a plurality of questions with which the correct answer rate of the at least one machine learning model becomes a value that corresponds to the criterion; and
outputting the one or the plurality of selected questions as a question collection for the learner.

2. The non-transitory computer-readable recording medium according to claim 1, wherein
the criterion is a value obtained by correcting a target correct answer rate set by the learner such that the target correct answer rate increases as the correct answer rate of the at least one machine learning model increases compared to the correct answer rate of the learner and the target correct answer rate reduces as the correct answer rate of the at least one machine learning model reduces compared to the correct answer rate of the learner.

3. The non-transitory computer-readable recording medium according to claim 1, wherein
the at least one machine model includes a plurality of machine learning models, and
the determining the criterion includes using, out of the plurality of machine learning models of different accuracies, a machine learning model a correct answer rate of which is closest to the correct answer rate of the learner.

4. The non-transitory computer-readable recording medium according to claim 3, the process further comprising:
generating the plurality of machine learning models of different accuracies by executing the machine learning in which either or both of a number of parameters included in the at least one machine learning model and a number of pieces of training data used for the machine learning of the at least one machine learning model are varied.

5. The non-transitory computer-readable recording medium according to claim 1, the process further comprising:
creating the plurality of questions by using a question creating model that is generated in advance by the machine learning so as to create sets of questions and answers from a text set.

6. The non-transitory computer-readable recording medium according to claim 5, the process further comprising:
executing the machine learning of the question creating model by using the text set and the sets of questions and answers that become correct answers as training data.

7. The non-transitory computer-readable recording medium according to claim 1, wherein
the determining of the criterion includes determining based on a difference between a correct answer rate of the at least one machine learning model for at least a subset of the plurality of questions and a correct answer rate of the learner for the subset of the questions.

8. The non-transitory computer-readable recording medium according to claim 1, wherein
the determining of the criterion includes storing the correct answer rate of the learner and the correct answer rate of the at least one machine learning model for a question, out of the plurality of questions, that has been previously output, and determining based on a difference between the stored correct answer rate of the learner and the stored correct answer rate of the at least one machine learning model.

9. An information processing apparatus comprising:
a memory; and
a processor coupled to the memory and configured to:
determine a criterion based on a difference between a correct answer rate of at least one machine learning model for a plurality of questions and a correct answer rate of a learner for the plurality of questions;
select, from among the plurality of questions, one or a plurality of questions with which the correct answer rate of the at least one machine learning model becomes a value that corresponds to the criterion; and
output the one or the plurality of selected questions as a question collection for the learner.

10. The information processing apparatus according to claim 9, wherein
the criterion is a value obtained by correcting a target correct answer rate set by the learner such that the target correct answer rate increases as the correct answer rate of the at least one machine learning model increases compared to the correct answer rate of the learner and the target correct answer rate reduces as the correct answer rate of the at least one machine learning model reduces compared to the correct answer rate of the learner.

11. The information processing apparatus according to claim 9, wherein
the at least one machine model includes a plurality of machine learning models, and
the processor uses, out of the plurality of machine learning models of different accuracies, a machine learning model a correct answer rate of which is closest to the correct answer rate of the learner.

12. The information processing apparatus according to claim 11, the processor generates the plurality of machine learning models of different accuracies by executing the machine learning in which either or both of a number of parameters included in the at least one machine learning model and a number of pieces of training data used for the machine learning of the at least one machine learning model are varied.

13. The information processing apparatus according to claim 9, the processor creates the plurality of questions by using a question creating model that is generated in advance by the machine learning so as to create sets of questions and answers from a text set.

14. The information processing apparatus according to claim 13, the processor executes the machine learning of the question creating model by using the text set and the sets of questions and answers that become correct answers as training data.

15. The information processing apparatus according to claim 9, wherein the processor determines the criterion based on a difference between a correct answer rate of the at least one machine learning model for at least a subset of the plurality of questions and a correct answer rate of the learner for the subset of the questions.

16. The information processing apparatus according to claim 9, wherein the processor stores the correct answer rate of the learner and the correct answer rate of the at least one machine learning model for a question, out of the plurality of questions, that has been previously output, and determines the criterion based on a difference between the stored correct answer rate of the learner and the stored correct answer rate of the at least one machine learning model.

17. A question collection creating method comprising:
determining a criterion based on a difference between a correct answer rate of at least one machine learning model for a plurality of questions and a correct answer rate of a learner for the plurality of questions;
selecting, from among the plurality of questions, one or a plurality of questions with which the correct answer rate of the at least one machine learning model becomes a value that corresponds to the criterion; and
outputting the one or the plurality of selected questions as a question collection for the learner.

18. The question collection creating method according to claim 17, wherein
the criterion is a value obtained by correcting a target correct answer rate set by the learner such that the target correct answer rate increases as the correct answer rate of the at least one machine learning model increases compared to the correct answer rate of the learner and the target correct answer rate reduces as the correct answer rate of the at least one machine learning model reduces compared to the correct answer rate of the learner.

19. The question collection creating method according to claim 17, wherein
the at least one machine model includes a plurality of machine learning models, and
the determining the criterion includes using, out of the plurality of machine learning models of different accuracies, a machine learning model a correct answer rate of which is closest to the correct answer rate of the learner.

20. The question collection creating method according to claim 19, the process further comprising:
generating the plurality of machine learning models of different accuracies by executing the machine learning in which either or both of a number of parameters included in the at least one machine learning model and a number of pieces of training data used for the machine learning of the at least one machine learning model are varied.
